(19) United States
(12) Patent Application Publication
(10) Pub. No.: US 2025/0310032 A1
(43) Pub. Date: Oct. 2, 2025

(54) TECHNOLOGIES FOR RADIO LINK CONTROL DATA PRIORITIZATION

(71) Applicant: Apple Inc., Cupertino, CA (US)

(72) Inventors: Ping-Heng Kuo, London (GB); Ralf Rossbach, Munich (DE); Fangli Xu, Beijing (CN); Naveen Kumar R. Palle Venkata, San Diego, CA (US); Peng Cheng, Beijing (CN); Alexander Sirotkin, Tel Aviv (IL); Zhibin Wu, Los Altos, CA (US); Haijing Hu, Los Gatos, CA (US); Yuqin Chen, Beijing (CN)

(73) Assignee: Apple Inc., Cupertino, CA (US)

(21) Appl. No.: 19/067,554

(22) Filed: Feb. 28, 2025

Related U.S. Application Data
(60) Provisional application No. 63/571,356, filed on Mar. 28, 2024.

(51) Int. Cl. H04L 1/08

(52) U.S. Cl. CPC H04L 1/08

(57) ABSTRACT

The present application relates to devices and components including apparatus, systems, and methods for prioritization and scheduling of radio link control (RLC) protocol data units (PDUs).

### CROSS-REFERENCES TO OTHER APPLICATIONS

This application claims priority to U.S. Provisional Application No. 63/571,356, for “TECHNOLOGIES FOR RADIO LINK CONTROL DATA PRIORITIZATION” filed on Mar. 28, 2024, which are herein incorporated by reference in their entirety for all purposes.

### TECHNICAL FIELD

This application relates generally to communication networks and, in particular, to the prioritization of radio link control (RLC) protocol data units (PDUs).

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates aspects of a user equipment in further detail in accordance with some embodiments.

FIG. 3 illustrates a timing diagram in accordance with some embodiments.

FIG. 4 illustrates a radio link control signal flow diagram in accordance with some embodiments.

FIG. 5 illustrates data flow in accordance with some embodiments.

FIG. 6 illustrates aspects of a transmitting entity in accordance with some embodiments.

FIG. 7 illustrates examples of prioritization at a transmitting entity in accordance with some embodiments.

FIG. 8 illustrates other examples of prioritization at a transmitting entity in accordance with some embodiments.

FIG. 9 illustrates another operation flow/algorithmic structure in accordance with some embodiments.

FIG. 10 illustrates another operation flow/algorithmic structure in accordance with some embodiments.

FIG. 11 illustrates another operation flow/algorithmic structure in accordance with some embodiments.

FIG. 12 illustrates an operation flow/algorithmic structure in accordance with some embodiments.

FIG. 13 illustrates a user equipment in accordance with some embodiments.

FIG. 14 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry,” as used herein, refers to, is part of, or includes hardware components that are configured to provide the described functionality. The hardware components may include an electronic circuit, a logic circuit, a processor (shared, dedicated, or group) or memory (shared, dedicated, or group), an application-specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry,” as used herein, refers to, is part of, or includes circuitry capable of sequentially and automatically carrying out a sequence of arithmetic or logical operations, recording, storing, or transferring digital data. The term “processor circuitry” may refer to an application processor, baseband processor, central processing unit (CPU), graphics processing unit, single-core processor, dual-core processor, triple-core processor, quad-core processor, or any other device capable of executing or otherwise operating computer-executable instructions, such as program code, software modules, or functional processes.

The term “interface circuitry,” as used herein, refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device, including a wireless communications interface.

The term “computer system,” as used herein, refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services accessible through a server where such system resources reside on a single host or multiple hosts and are clearly identifiable.

The term “channel,” as used herein, refers to any transmission medium, either tangible or intangible, that is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link,” as used herein, refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during the execution of program code.

The term “connected” may mean that two or more elements at a common communication protocol layer have an established signaling relationship with one another over a communication channel, link, interface, or reference point.

The term “network element,” as used herein, refers to physical or virtualized equipment or infrastructure used to provide wired or wireless communication network services. The term “network element” may be considered synonymous with or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

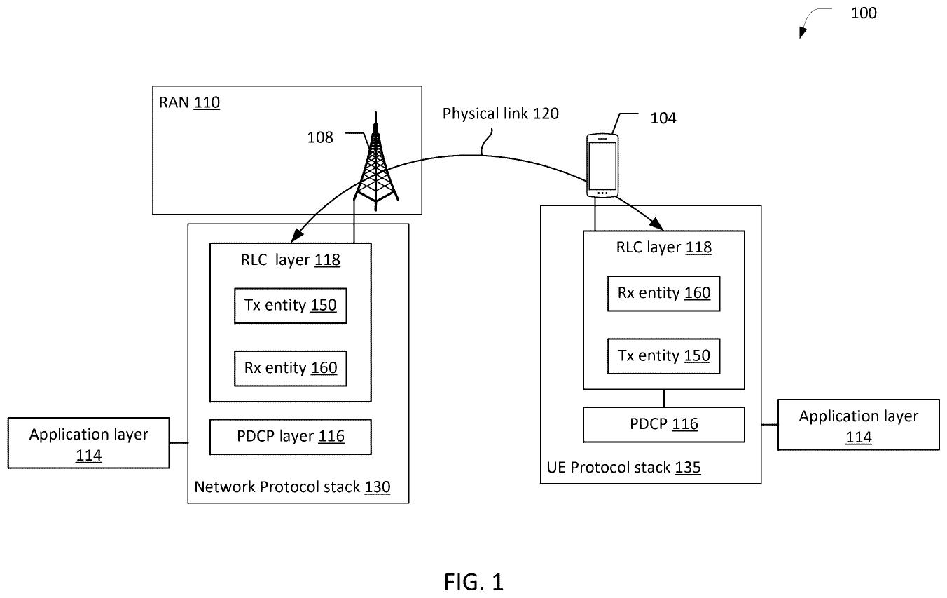

FIG. 1 illustrates a network environment 100 in accordance with some embodiments. The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The 3GPP TSs may define a protocol stack, e.g., network protocol stack 130 or UE protocol stack 135. The protocol stack may be a set of communication protocols. In some examples, the protocol stack may be designed in a layered architecture for modularity, with each layer providing specific functions. The design may allow changes in one layer without affecting others, facilitating upgrades and improvements. The layers may include a physical layer (Layer 1, L1, or PHY) responsible for establishing and maintaining a physical link 120. Bits of control and data may transmit over the air interface and the physical link 120. The protocol stack, e.g., network protocol stack 130 or UE protocol stack 135, may include a data link layer (Layer 2, L2), which may be divided into a medium access control (MAC), a radio link control (RLC) 118, and a packet data convergence protocol (PDCP) 116 sub-layers. Layer 2 may be responsible for managing the UE 104 connectivity and movement between cells and networks. In some instances, application layer 114 is not included in the protocol stack.

The RLC 118 sub-layer may be responsible for reliable data transmission. The RLC 118 may include a transmitting entity 150 and a receiving entity 160. The transmitting entity 150 at the transmitting end may segment the data from higher layers, e.g., PDCP layer 116 or application layer 114, and add sequence numbers and headers. These packets may then be transmitted over the air interface, e.g., via the physical link 120. At the receiver end, the receiving entity 160 of the RLC layer 118 may reassemble the packets back into the original data, e.g., using the sequence numbers and header information to ensure correct order and to detect any missing packets. If a packet is detected as missing or erroneous, the RLC layer 118 at the receiver can request retransmission from the transmitter.

In the downlink transmission, the base station 108 is the transmitting end, and the UE 104 is the receiving end. The transmitting entity 150 of the RLC 118 of the base station 108 sends the packets via the physical link 120 to the UE 104. The receiving entity 160 of the RLC layer 118 of the UE 104 receives and reassembles the packets. In some embodiments, the packet transmitted by an RLC layer 118 may be referred to as an RLC protocol data unit (PDU).

The receiving entity 160 of RLC layer 118 of the base station 108 may be called a peer entity to the transmitting entity 150 of RLC layer 118 of the UE 104. Similarly, the receiving entity 160 of RLC layer 118 of the UE 104 may be called a peer entity to the transmitting entity 150 of RLC layer 118 of the base station 108.

In some instances, a packet received by a layer from higher layers is called the service data unit (SDU) of that layer. The packet transmitted by the layer to lower layers is called the PDU of that layer. For example, packets received to PDCP layer 116 are called PDCP SDUs, and packets sent from PDCP layer 116 to RLC layer 118 are called PDCP PDUs.

The RLC layer 118 may be configured as an acknowledgment mode (AM) RLC. In AM RLC, each transmitted PDU is assigned a sequence number. The receiver may send acknowledgments (ACKs) for correctly received PDUs and negative acknowledgments (NACKs) for missing or erroneous PDUs. Upon receiving a NACK, or in the absence of an ACK associated with a PDU, the transmitter may retransmit the corresponding PDU.

In some embodiments, the application layer 114 may generate packets and group them in PDU sets. The PDCP layer 116 may receive the packets and generate PDCP PDUs. Each PDCP PDU may be associated with one or more application layer packets or a PDU set. The RLC layer 118 may receive the PDCP PDUs and generate RLC PDUs. Each RLC PDU may be associated with one or more PDCP PDUs and similarly may be associated with one or more application layer packets or a PDU set.

In some embodiments, when a PDCP SDU is received from the upper layer, the transmitting PDCP entity may start a discard timer. The discard timer may track the buffered time of each SDU at the PDCP layer 116. In some instances, when the discard timer expires for a PDCP SDU, or the successful delivery of the PDCP SDU is confirmed, e.g., via an ACK, the transmitting PDCP entity may discard the PDCP SDU along with the corresponding PDCP PDU.

In some instances, discarding PDCP SDUs that are not successfully delivered may not prevent the retransmission of the entire PDU set associated with the discarded PDCP SDUs. Retransmission of the entire PDU set associating to discarded PDCP SDUs may be unnecessary, inefficient, waste network resources, increase latency, and/or negatively impact the user experience. It is desirable to prevent PDCP SDU discarding due to discard timer expiry.

In some embodiments, RLC PDUs may be identified as delay-critical based on the discard timer of their respective PDCP PDUs. RLC layer 118 may prioritize the transmission or retransmission of delay-critical RLC PDUs. For example, the transmitting entity 150 may prioritize delay-critical acknowledgment mode (AM) data (AMD) RLC PDUs regardless of whether they are for initial transmission or retransmission.

In some embodiments, the transmitting entity 150 may first identify the delay criticality of AMD PDUs and exclude the AMD PDUs that are not delay-critical. Among all the delay-critical AMD PDUs, the transmitting entity 150 of the RLC layer 118 may prioritize retransmission over initial transmission.

In some embodiments, the transmitting entity 150 may first identify AMD PDUs for retransmission and exclude the AMD PDUs for initial transmission. Among the AMD PDUs for retransmission, the transmitting entity 150 may prioritize the delay-critical AMD PDUs.

In some embodiments, the transmission of AMD PDUs containing delay-critical RLC SDUs or RLC SDU segments can also be prioritized over RLC control PDUs, e.g., status PDUs.

In some embodiments, The RLC layer 118 may obtain the remaining time till discarding of the PDCP SDUs corresponding to the RLC SDUs and determine the prioritization based on the remaining time until the corresponding PDCP SDUs is discarded.

In some embodiments, the transmitting entity 150 may apply prioritization based on the remaining time when at least one AMD RLC PDU is considered delay-critical. In some instances, when none of the AMD PDUs are considered delay-critical, the transmitting entity 150 may apply the legacy behavior, e.g., prioritize retransmission over initial transmission.

In some embodiments, the AMD PDUs, initial transmission or retransmission, may be prioritized over RLC control PDUs, e.g., status PDUs, if the remaining times till discarding of their corresponding PDCP SDUs are smaller than a threshold.

In some embodiments, if the remaining time till discarding for a PDCP SDU, or its associated PDU set, is smaller than (or equal to) a threshold, e.g., 1 millisecond (ms) or 2 ms, the RLC layer 118 may not prioritize RLC SDUs or RLC SDU segments corresponding to such PDCP SDUs, even if they are considered delay-critical.

The transmitting entity 150 may be configured with a first and second threshold. The transmitting entity 150 may prioritize the AMD RLC PDUs that contain a delay-critical RLC SDU or SDU segment whose remaining time is larger than (or equal to) the first threshold and smaller than (or equal to) the second threshold.

In some embodiments, the AMD RLC PDUs, initial transmission or retransmission, may be prioritized over RLC control PDUs, e.g., status PDU, when the remaining time till discarding of their corresponding PDCP SDUs falls into the range between the first threshold and the second threshold.

In some embodiments, a pending AMD RLC PDU may be retransmitted autonomously, even if the transmitter does not receive any positive or negative acknowledgement for this pending AMD RLC PDU. Whether a pending AMD RLC PDU may be retransmitted autonomously may depend on if its corresponding RLC SDU is a delay-critical RLC SDU or has became a delay-critical RLC SDU.

In some embodiments, the prioritization rule, in addition to considering delay-criticality, may consider whether the AMD RLC PDU contains RLC SDU or SDU segments that correspond to one or more packets of an important PDU set or a less important PDU Set. Whether a PDU Set is important or less important may be determined based on PDU Set importance (PSI) associating to the PDU Set.

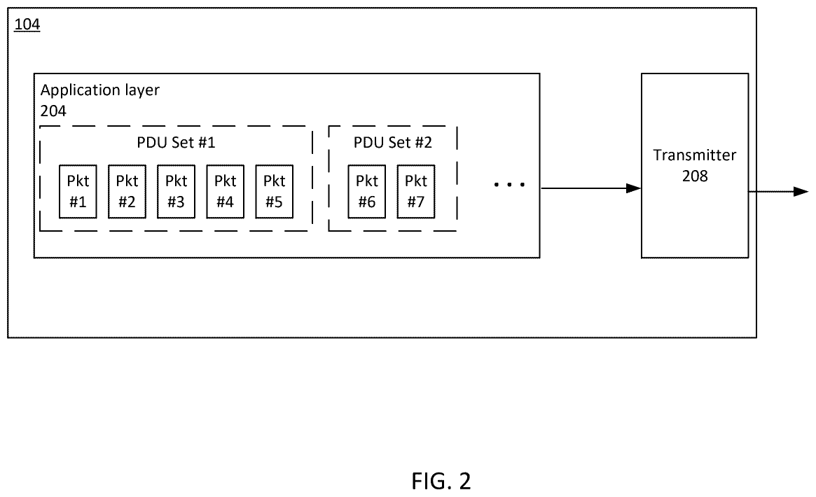

FIG. 2 illustrates aspects of the UE 104 in further detail in accordance with some embodiments. The UE 104 may include an application layer 204 that generates application traffic to be transmitted to another device through the network environment 100. In some embodiments, the application layer 204 may have an XR application that generates XR traffic. However, embodiments are not limited to XR use cases.

For XR and other services, the application layer 204 may generate PDU sets, with individual PDU sets comprising one or more packets. A packet also referred to as a PDU, may be an Internet protocol (IP) packet or a non-IP packet. As shown, PDU set #1 may include packets #1-#5, while PDU set #2 includes packets #6 and #7. Each PDU set may be mapped to a different QoS flow. Different PDU sets may be mapped to different traffic flows when they correspond to different traffic flows or modalities.

The packets of a PDU set may carry a payload of one unit of information generated by the application layer. The unit of information may be a frame or video slice for XR Services, such as those defined in 3GPP Technical Report (TR) 26.926 v18.1.0 (2024 January), for example. In some implementations, all PDUs in the PDU Set may be needed by an application layer at a destination node to allow the application layer to recover parts or all of the information unit. In other implementations, the application layer on the destination node may still be able to recover parts or all of the information unit, even if some PDUs of a PDU set are missing.

In some embodiments, the data produced by an application layer of the UE 104 may include multi-modal data. Multi-modal data may include input data from different devices/sensors or output data to different destinations (e.g., one or more UEs) desired for the same task or application. Multi-modal data may include more than one single-modal data (e.g., one type of data), and there may be a strong dependency among each single-modal data associated with multi-modal data.

In some embodiments, the data produced by an application layer may be in a data burst. A data burst may include, for example, data produced by the application layer in a short period of time. The data burst may include PDUs from one or more PDU Sets.

The PDU sets may be provided to a transmitter 208 of the UE 104. The transmitter 208 may be configured to execute a communication protocol stack, for example, UE protocol stack 135 of FIG. 1, to facilitate communication via the network environment 100. The transmitter 208 may implement L2 and L1 functionality. At the L2 level, transmitter 208 may include a service data adaptation protocol (SDAP) layer, a PDCP layer, an RLC layer, and a MAC layer. At the L1 level, the transmitter 208 may include a physical (PHY) layer. Briefly, the SDAP layer may manage QoS flow handling between the QoS flows and the data radio bearers (DRBs). The PDCP layer may manage robust header (de)compression and security between DRBs and RLC channels. The RLC layer may manage (re-)segmentation and error correction through automatic repeat requests (ARQ) between logical channels and RLC channels. The MAC layer may manage scheduling/priority handling, (de)multiplexing, and hybrid automatic repeat request (HARQ) processes between logical channels and transport channels. The PHY layer may manage the processing of the physical data and control channels.

In some embodiments, various information may be provided by the core network node 106 to the RAN 110 to assist in handling QoS flows and PDUs. This information may be consistent with that described in 3GPP TR 23.700-60 v18.0.0 (2022 Dec. 21). This information may include semi-static information for both uplink and downlink, PDU set QoS parameters, and dynamic information for downlink.

The semi-static information for both uplink and downlink may be provided via the control plane (NGAP). This information may include periodicity for uplink and downlink traffic of the QoS Flow via time-sensitive communications assistance information (TSCAI)/time-sensitive communications assistance container (TSCAC); and traffic jitter information (e.g., jitter range) associated with each periodicity of the QoS flow.

The PDU set QoS parameters may include a PDU Set Error Rate (PSER) to define an upper bound for the rate of PDU Sets that have been processed by the sender of a link layer protocol but that are not successfully delivered by the corresponding receiver to the upper layer. See, for example, 3GPP TR 23.700-60. In some instances, a PDU set may be considered as successfully delivered when all PDUs of a PDU Set are delivered successfully. In other instances, other definitions of successful delivery may be made. In some instances, if one PDU of a PDU set is discarded, all remaining PDUs of the PDU set may be discarded.

The PDU set QoS parameters may further include a PDU Set Delay Budget (PSDB) that defines a time between the reception of a first PDU and the successful delivery of a last-arrived PDU of a PDU Set. See, for example, 3GPP TR 23.700-60. The PSDB may be an optional parameter in various embodiments.

The PDU set QoS parameters may further include a PDU Set importance (PSI) to indicate the relative importance of a PDU set compared to other PDU sets within the same QoS flow.

A PDU set may be associated with the following information: a PDU set sequence number (SN); a PDU set size (in bytes); a PDU SN within a PDU Set; an end PDU of the PDU Set indication; a PDU set importance (PSI); and an end of data burst indication in the header of a last PDU of the data burst. The PSI may be used to identify the importance of a PDU Set within a QoS flow. The RAN 110 may use the PSI for PSI-based discarding in the presence of congestion, as described herein.

The application, application server, application function, or application layer 114 may assign a PSI level for each packet or PDU set or may define rules and policies for assigning a PSI level to a type of packet or PDU set. For example, the application may assign a PSI level to packets associated with audio data and a different PSI to packets or PDU sets associated with real-time video data. The application may assign different PSI to payloads associated with different video frame types within a video stream. PSI level selection may be influenced by factors such as type of application (e.g., video, audio, text), details of codec (e.g., H.264 or high-efficiency video coding, HEVC), level of error propagation when a PDU set is discarded, or inter-dependency among PDU sets (e.g., whether a PDU set is necessary for the processing of some other PDU sets). The PSI selection may be similar to that described in 3GPP TS 26.522 v 0.4.0 (2024 Mar. 1).

PSI may have N levels, e.g., levels 0 to N−1. The higher PSI level values may be associated with less importance. Some of the PSI levels may indicate no interdependency with other PDU sets. For example, there may be 16 levels of PSIs, e.g., level 0 to level 15. PSI levels 14 and 15 may indicate no inter-dependency to other PDU sets; e.g., a PDU set having PSI level 14 may not have inter-dependency to other PDU sets. PDU sets with other PSI levels, e.g., levels 0 to 13, may be needed to process other PDU sets. These values may differ in other embodiments.

In some instances, the base station 108 may instruct the UE 104 to apply different discarding timers for PDU sets with different PSIs. For example, a PDU set with a large PSI level may have a shorter discard timer than a PDU set with a smaller PSI level.

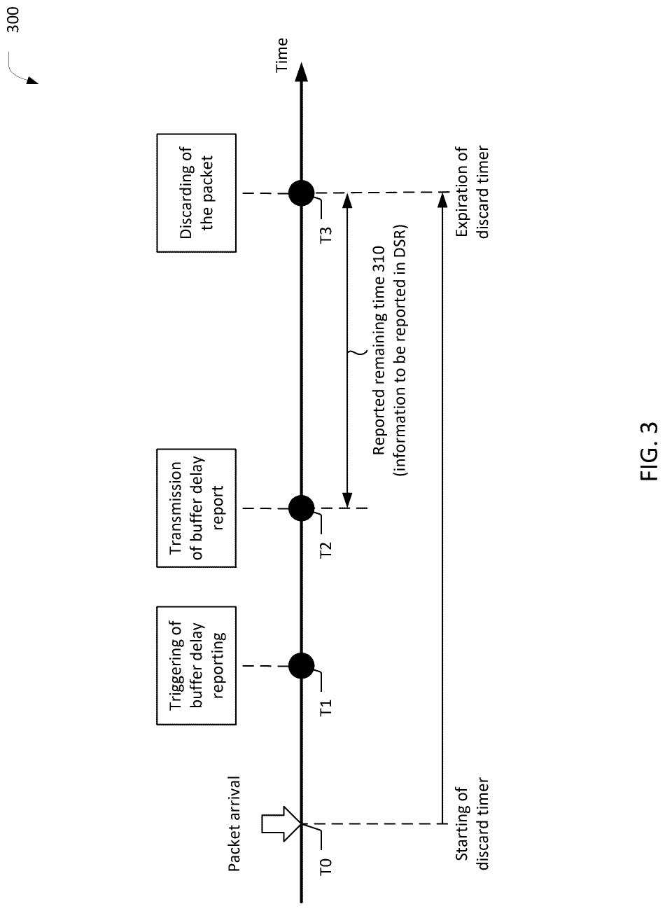

FIG. 3 illustrates a timing diagram 300 for generating and transmitting a delay status report in accordance with some embodiments. The delay status reporting (DSR) may assist in delay-aware scheduling. A DSR may be triggered when the remaining time till the data is discarded is below a threshold.

At T₀, a buffer of a transmitting entity (e.g., UE PDCP transmitting entity in uplink transmission or base station PDCP transmitting entity in downlink transmission) and associated with a logical channel (LCH) or a logical channel group (LCG) can receive a data packet for transmission. At T₀, the transmitting entity can start a discard timer, in which it will discard the data if, by expiration of the timer, the transmitting entity has not successfully transmitted the data packet. At T₁, a first time interval (e.g., T₃-T₁) is reached, where the time remaining prior to the expiration of the discard timer has reached a threshold, such that a delay status report (DSR) is triggered. At T₂, a DSR report is generated and transmitted. The DSR can include data volume information. For example, the DSR may include the buffer size or a reported remaining time 310, when the DSR is transmitted. The reference point for measuring the reported remaining time 310 may be the transmission of DSR. UE may report the DSR in a MAC control element (CE).

As mentioned above, DSR may include buffer size. The UE may determine the buffer size through data volume calculation. 3GPP TS 38.323 v. 18.0.0 (2024 January) describes data volume calculation for delay status reporting.

3GPP TS 38.323 introduces delay-critical PDCP SDUs to calculate buffer size for the DSR. Similarly, 3GPP TS 38.322 v. 18.0.0 (2024 January) introduces delay-critical RLC SDUs to calculate buffer size for DSR.

The delay-critical PDCP SDU may be defined as a PDCP SDU for which the remaining time till discarding is less than a first threshold when PDU set discarding is not configured. When the PDU set discarding is configured, a PDCP SDU is delay-critical if it belongs to a PDU set in which at least one PDCP SDU has the remaining time till discarding less than a second threshold. Note that the remaining time till discarding is the actual remaining time of the discard timer, whereas the reported remaining time 310 is the remaining time on the discard timer at the time of generating or transmitting the DSR. Similarly, a delay-critical RLC SDU is defined as an RLC SDU corresponding to a PDCP PDU indicated as delay-critical by PDCP.

In some instances, for the purpose of MAC delay status reporting, the transmitting PDCP entity may be considered as delay-critical PDCP data volume: 1) the delay-critical PDCP SDUs for which no PDCP Data PDU have been constructed; 2) the PDCP Data PDU that contain the delay-critical PDCP SDUs and have not been submitted to lower layers; 3) the PDCP Control PDUs; 4) for AM data radio bearers (DRBs), the PDCP SDUs to be retransmitted; and 5) for AM DRBs, the PDCP Data PDUs to be retransmitted.

In some instances, for the purpose of MAC buffer status reporting, the UE may consider the following as RLC data volume: 1) RLC SDUs and RLC SDU segments that have not yet been included in an RLC data PDU; 2) RLC data PDUs that are pending for initial transmission; and 3) RLC data PDUs that are pending for retransmission (RLC AM). Additionally, the UE may also consider the following as delay-critical RLC data volume: 1) delay-critical RLC SDUs and delay-critical RLC SDU segments that have not yet been included in an RLC Data PDU; 2) RLC Data PDUs pending for initial transmission and containing a delay-critical RLC SDU or a delay-critical RLC SDU segment; and 3) RLC Data PDUs that are pending for retransmission (RLC AM). In addition, if a status PDU has been triggered and a prohibition timer, t-StatusProhibit, is not running or has expired, the UE may estimate the size of the status PDU that will be transmitted in the next transmission opportunity and consider this as part of RLC data volume for MAC buffer status reporting and as part of delay-critical RLC data volume for MAC delay status reporting.

In some embodiments, an identifier associated with an RLC SDU may indicate whether it is delay-critical, e.g., a one-bit indicator. RLC PDUs may be considered delay-critical if they are associated with delay-critical RLC SDUs or delay-critical RLC SDU segments. RLC Data PDUs of both initial transmission or retransmission may be considered as delay-critical.

In some embodiments, an RLC SDU or SDU segment may be associated with a parameter associated with the discard timer or the PDCP SDU associated with the RLC SDU or SDU segment. The parameter may include a value of the remaining time till discarding, e.g., the remaining time till the discard timer expires.

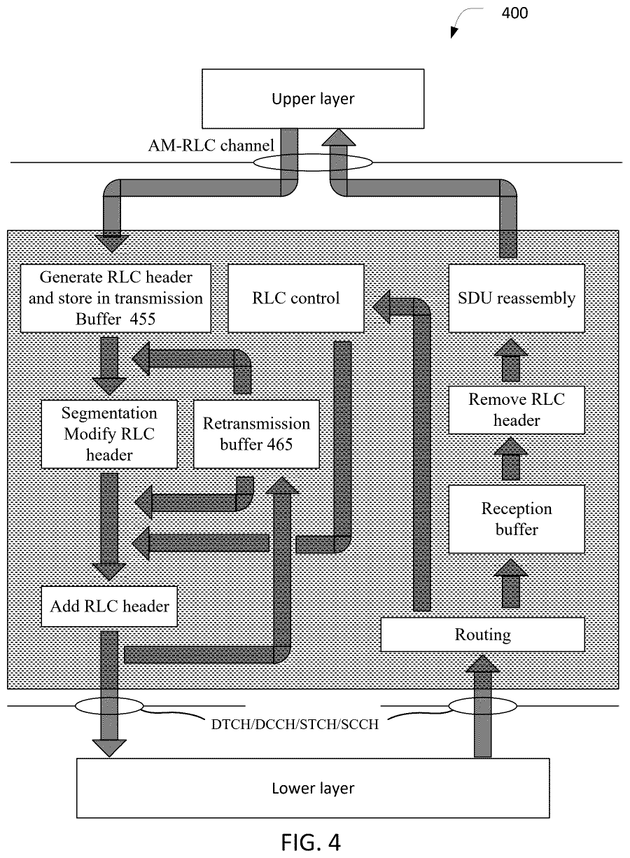

FIG. 4 illustrates an RLC signal flow diagram 400 in accordance with some embodiments. Signal flow diagram 400 is an example of functionalities performed by the RLC layer, e.g., RLC layer 118 in FIG. 1.

An example of an AM RLC entity is described in 3GPP TS 38.322. An AM RLC entity may be configured to submit or receive RL CPDUs through the following logical channels: downlink (DL) or uplink (UL) dedicated control channel (DCCH), DL or UL dedicated traffic channel (DTCH), sidelink control channel (SCCH), and sidelink traffic channel (STCH).

An AM RLC entity may deliver or receive the following RLC Data PDUs: AMD PDU. An AMD PDU may contain either one complete RLC SDU or one RLC SDU segment. An AM RLC entity may deliver or receive the following RLC control PDU: status PDU. The status PDU may be used to provide the status of the PDUs that are correctly received and lost during transmission. It is sent from the RLC receiving entity, e.g., receiving entity 160 in FIG. 1, to the transmitting entity, e.g., transmitting entity 150 in FIG. 1. The status PDU may contain an ACK or NACK sequence number.

The transmitting side of an AM RLC may generate AMD PDU(s) for each RLC SDU. Upon receiving a transmission opportunity from the lower layer, the transmitting side of the AM RLC entity may break down the RLC SDUs into segments. This is done so that the resulting AMD PDUs, with appropriately updated RLC headers, can fit within the total size of the RLC PDU(s) specified by the lower layer.

The transmitting side of an AM RLC entity may also support the retransmission of RLC SDUs or RLC SDU segments. If the RLC SDU or RLC SDU segment to be retransmitted (including the RLC header) exceeds the total size of the RLC DU(s) specified by the lower layer at a given transmission opportunity, the AM RLC entity may break down the RLC SDU into segments or resegment the RLC SDU segments into smaller segments.

When the AM RLC entity on the receiving end receives AMD PDUs, it may identify if there are any duplicated AMD PDUs and discard them. The AM RLC may also recognize if any AMD PDUs have been lost at lower layers and ask its peer AM RLC entity for retransmission. Finally, the AM RLC may reassemble the RLC SDUs from the AMD PDUs it received and pass the RLC SDUs to the upper layer as soon as they are ready.

AM RLC may include two buffers. The first buffer may be the transmission buffer 455. The transmission buffer 455 may store RLC AMD PDUs. After an RLC PDU has been transmitted, a similar copy is stored in the retransmission buffer 465, the second buffer. If the RLC receives a NACK or does not get any positive response, the RLC PDU from the retransmission buffer may be transmitted again.

The transmitting side of an RLC transmitting entity, e.g., transmitting entity 150, may solicit a status PDU from its peer entity at the receiving side. For example, the transmitting entity 150 of the base station 108 may solicit a status PDU from the receiving entity 160 of the UE 104, or the transmitting entity 150 of the UE 104 may solicit a status PDU from the receiving entity 160 of the base station 108.

The transmitting side may solicit a status PDU from its peer entity through the header of an AMD PDU. The transmitting side may set a polling flag in the header of an AMD PDU sent to the receiving side. The transmitting side may set the polling flag when the total number of PDUs transmitted since the last poll exceeds a threshold, e.g., the configured pollPDU threshold; when the total number of bytes transmitted since the last poll exceeds another threshold, e.g., the configured pollByte threshold; when the transmission and retransmission buffer becomes empty after the transmission of the current AMD PDU; when no new RLC SDU can be transmitted after the transmission of the AMD PDU, e.g., due to window stalling; or when the poll retransmit timer expires. Once the polling flag is set, a status PDU from the receiving side is solicited. This mechanism may allow the transmitting side to request its peer to send the current status.

Once the polling flag is set, e.g., by setting the poll bit to ‘1’ in an AMD PDU, the transmitting side may start or restart a poll retransmit timer. For example, the transmitting side may start a configured t-PollRetransmit timer. The timer is stopped when a status PDU is received. If the timer expires, the transmitting side may initiate data retransmission or retransmit the poll.

In some instances, the receiving side may determine which PDUs to report based on the sequence numbers (SNs) and segment offsets (SOs) of the received AMD PDUs. The report may be a control PDU, e.g., status PDU. The receiving side may generate the status report and include the SNs of the received PDUs and the SNs of the lost PDUs or segments. TS 38.322 describes RLC AM polling and associated operations and timers, e.g., the t-PollRetransmit timer.

In some instances, the transmitting side of an AM RLC entity may maintain a transmitting window. The transmitting window may provide orderly transmission of AMD PDUs. It may be used to control the number of PDUs that can be transmitted before receiving an acknowledgment. Two parameters may determine the transmitting window: 1) parameter “AM_Window_Size,” which is the size of the window in terms of the number of PDUs, and 2) parameter TX_Next_Ack, which is the sequence number of the next RLC SDU for which a positive acknowledgment is expected to be received in-sequence. If an AMD PDU has a sequence number, PDU_SN, that is greater than or equal to the TX_Next_Ack and smaller than Tx_Next_Ack+AM_Window_Size, the AMD PDU may be transmitted.

The Tx_Next_Ack may serve as the lower edge of the transmitting window. The Tx_Next_Ack+AM_Window_Size may serve as the upper edge of the transmitting window. A new RLC SDU with SN outside the transmitting window cannot be transmitted. Therefore, it is desirable for the transmitting window to move forward as quickly as possible. When the transmitting window moves forward, the subsequent new packets are less likely to be delayed by window stalling. The transmitting window will move forward by receiving ACK for PDUS with SN equal to Tx_Next_Ack. The transmitter may proactively request ACK or NACK e.g. via a polling mechanism from the receiver side.

In some instances, some RLC SDUs (or their segments) may be considered for retransmission. For example, when the peer RLC entity does not positively acknowledge some RLC SDUs. Retransmission of an RLC SDU may be performed several times before it is positively acknowledged. In some instances, the number of retransmissions may be capped by a threshold, e.g., configured threshold maxRetxThreshold.

When an RLC SDU or an RLC SDU segment is considered for retransmission, a counter, e.g., configured RETX_COUNTER, may be assigned to the RLC SDU or RLC SDU segment that is being retransmitted. If the RLC SDU or RLC SDU segment is being considered for retransmission for the first time, the counter is set to zero, e.g., RETX_COUNT=0. The counter may be incremented if the RLC SDU or its segment is not pending for retransmission and the RETX_COUNT associated with the RLC SDU has not been incremented due to another NACK in the same status PDU.

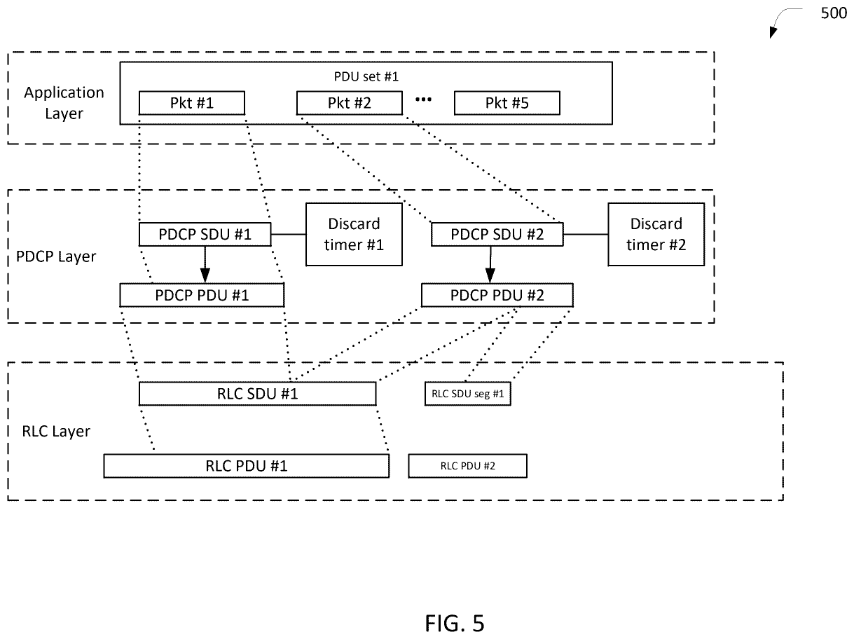

FIG. 5 illustrates data flow 500 in accordance with some embodiments. Data flow 600 is a logical example diagram of protocol layers, and the data flow through various layers. Application layer, e.g., application layer 204 in FIG. 2, may generate PDU set #1, including packets #1-#5. Packet #1 of the PDU set #1 may be mapped to PDCP SDU #1. Upon receiving the PDCP SDU #1, the PDCP layer may configure and start a discard timer #1 and associate it with the PDCP SDU #1. Similarly, Packet #1 of the PDU set #1 may be mapped to PDCP SDU #2. Upon receiving the PDCP SDU #2, the PDCP layer may configure and start a discard timer #2 and assign it to the PDCP SDU #2.

PDCP layer may include PDCP SDU #1 in PDCP PDU #1. PDCP PDU #1 may also include a header and other information. Similarly, PDCP SDU #2 may be included in PDCP PDU #2 with other information.

At the RLC layer, PDCP PDU #1 and a PDCP PDU #2 segment may be included in RLC SDU #1. The remaining of the PDCP PDU #2 may be included in RLC SDU segment 1. RLC SDU #1 may be included in RLC PDU #1 along with RLC header and other information. Similarly, RLC SDU segment #1 may be included in RLC PDU #2 along with the RLC header and other information.

There might be two ways that an RLC SDU may become delay-critical. In one example, the RLC SDU is delay-critical and is associated with a delay-critical PDCP PDU. A PDCP PDU may be delay-critical if it is associated with a delay-critical PDCP SDU. As described above, a PDCP SDU may become delay-critical when the remaining time of the associated discard timer is less than a threshold. For example, if PDCP SDU #2 becomes delay-critical, then PDCP PDU #2, RLC SDU #1, RLC SDU segment #1, RLC PDU #1, and RLC PDU #2 will become delay-critical as well.

In a second example, the RLC SDU or PDU may become delay-critical if it is associated with a PDU set where a packet of that PDU set is associated with a delay-critical PDCP SDU. For example, if PDCP SDU #1 becomes delay-critical, in the first example, only RLC SDU #1 and RLC PDU #1 would become delay-critical and RLC SDU segment #1 and RLC PDU #2 would not become delay-critical. However, in the second example, when PDCP SDU #1 becomes delay-critical, it is associated with packet #1 of PDU set #2. Therefore, PDCP SDU #2 associated with packet #2 of the PDU set #1 would also become delay-critical. Consequently, PDCP PDU #2, RLC SDU segment #1, RLC PDU #2, PDCP PDU #1, RLC SDU #1, and RLC PDU #1 would become delay-critical.

Due to the nature of PDU sets, in some instances, when a packet becomes delay-critical, many other packets belonging to the same PDU set may also become delay-critical, e.g., when the PDU set discard is configured.

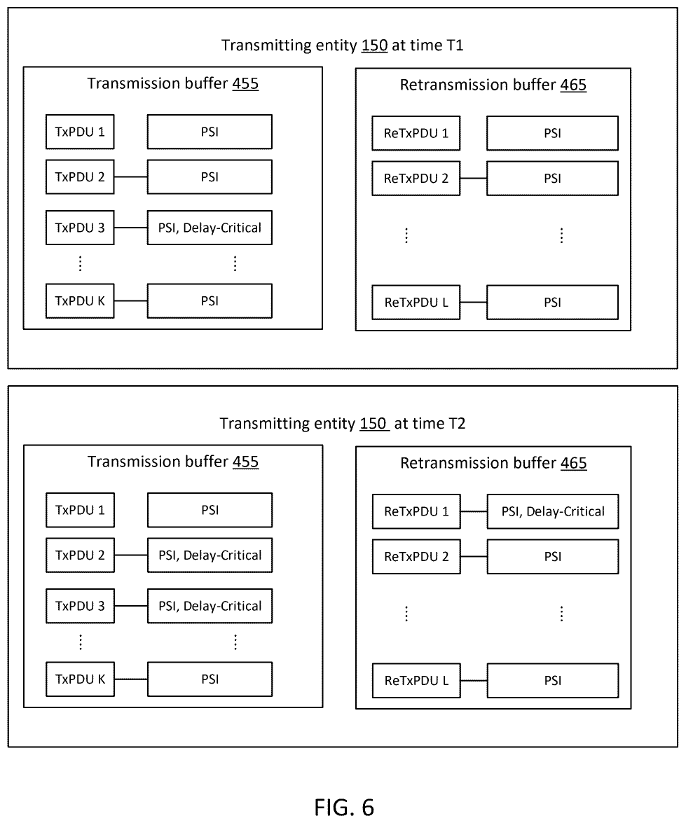

FIG. 6 illustrates aspects of an RLC transmitting entity 600 in accordance with some embodiments. RLC Transmitting entity 150 is illustrated at two different times, T1 and T2. Transmitting entity 150 includes a transmission buffer 455, and a retransmission buffer 465.

At time T1, transmission buffer 455 may store transmitting PDUs 1-K. Only transmitting PDU 3 may be delay-critical. Similarly, retransmission buffer 465 may store retransmitting PDUs 1-L. None of the retransmitting PDUs may be delay-critical. In some instances, information may be associated with each PDU in the transmission buffer 455 or retransmission buffer 465. Information may include a PSI field or a delay-critical indicator.

At time T2, transmitting PDU 2 and retransmitting PDU 1 may become delay-critical. For example, the discarding timer associated with the transmitting PDU 2 and retransmitting PDU 1 may become smaller than a threshold. The transmitting entity 150 at T2 may update information associated with transmitting PDU 2 and retransmitting PDU 1 accordingly to reflect that these PDUs are delay-critical.

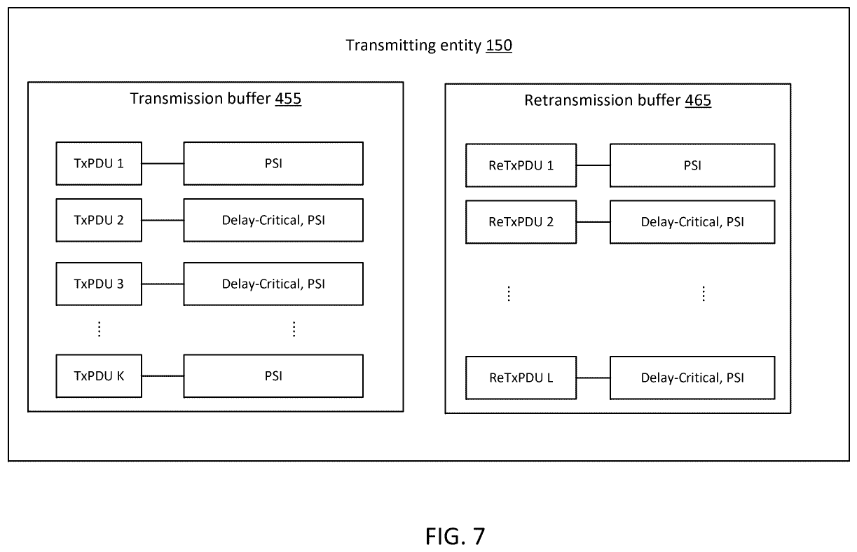

FIG. 7 illustrates examples of prioritization at a transmitting entity 150 in accordance with some embodiments. The transmitting entity may include a transmission buffer 455. Transmission buffer 455 may contain RLC PDUs buffered for transmission, e.g., TxPDU 1-K. Each RLC PDU may be associated with one or more parameters. In some embodiments, each RLC PDU may be associated with a delay-critical indicator. One or more parameters associated with an RLC PDU may include a delay-critical indicator. The delay-critical indicator may indicate whether the associated RLC PDU is a delay-critical RLC PDU. For example, a value ‘1’ of the delay-critical indicator may indicate that the RLC PDU is a delay-critical RLC PDU.

In some embodiments, each RLC PDU may be associated with a PSI. One or more parameters may include a PSI. The PSI of the RLC PDU may be the PSI of the corresponding PDU set.

In some embodiments, the transmitting entity 150 of an AM RLC may prioritize transmission of AMD PDUs containing delay-critical RLC SDUs or RLC SDU segments over transmission of AMD PDUs containing RLC SDUs or RLC SDU segments that are not delay-critical, e.g., non-delay-critical RLC SDUs or SDU segments. In some embodiments, the transmitting entity 150 may consider PSI in addition to delay-criticality for prioritizing RLC PDUs.

In some embodiment, the transmitting entity 150 may prioritize delay-critical AMD PDUs regardless of whether it is for initial transmission or retransmission. The transmitting entity 150 may select a delay-critical RLC PDU from the delay-critical RLC PDUs for transmission and may deliver it to lower layers. The selection of the delay-critical RLC PDUs among the delay-critical RLC PDUs may be a proprietary implementation. For example, the transmitting entity 150 may prioritize delay-critical RLC PDUs TxPDU 2 and TxPDU 3 in transmission buffer 455 and ReTxPDU 2 and ReTxPDU L in retransmission buffer 465 over all other non-delay-critical RLC PDUs in transmission buffer 455 and retransmission buffer 465. The transmitting entity 150 may select a PDU among TxPDU 2, TxPDU 3, ReTxPDU 2, and ReTxPDU L for transmission and delivery to the lower layer. In some embodiments, the transmitting entity 150 may consider PSI in addition to delay-criticality for prioritizing RLC PDUs. The transmitting entity 150 may select the RLC PDU to be transmitted among prioritized RLC PDUs based on the PSIs associated with each RLC PDU. For example, the transmitting entity 150 may compare the PSI of TxPDU 2, TxPDU 3, ReTxPDU 2, and ReTxPDU L and select the most important RLC PDU, e.g., the one with the smallest PSI, for transmission and delivery to the lower layer.

In some instances, the transmitting side of an AM RLC entity may be expected to prioritize the transmission of RLC control PDUs over AMD PDUs. If prioritizationDelayCritical is not configured, the transmitting side of an AM RLC entity may prioritize the transmission of AMD PDUs containing previously transmitted RLC SDUs or RLC SDU segments over the transmission of AMD PDUs containing not previously transmitted RLC SDUs or RLC SDU segments. If prioritizationDelayCritical is configured, the transmitting side of an AM RLC may prioritize transmission of AMD PDUs containing (segments of) delay-critical RLC SDUs over the transmission of AMD PDUs without (segments of) delay-critical RLC SDUs. Parameter prioritizationDelayCritical may be a parameter in the information element (IE) of radio resource control (RRC) configuration, e.g., RLC-Config. For example, prioritizationDelayCritical may be a parameter for RLC AM in a 3GPP TS, which may enable the prioritization of AMD PDUs containing delay-critical RLC SDUs (segments) over AMD PDUs without delay-critical RLC SDUs (segments).

In some embodiments, the transmitting entity 150 may first identify the delay-criticality of AMD PDUs and exclude the AMD PDUs that are not delay-critical. Among all the delay-critical AMD PDUs, the AM RLC transmitting entity 150 may prioritize retransmission PDUs over initial transmission PDUs. If there are no retransmission PDUs, the transmitting entity 150 may select an RLC PDU for transmission among the initial transmission delay-critical RLC PDUs. For example, the transmitting entity 150 may determine delay-critical PDUs, e.g., TxPDU 2, TxPDU 3, ReTxPDU 2, and ReTxPDU L and exclude all other RLC PDUs. Among TxPDU 2, TxPDU 3, ReTxPDU 2, and ReTxPDU L, the transmitting entity may prioritize retransmission PDUs, e.g., ReTxPDU 2 and ReTxPDU L, over the initial transmission PDUs, e.g., TxPDU 2, and TxPDU 3. In some embodiments, the transmitting entity 150 may consider PSI in addition to delay-criticality for prioritizing RLC PDUs. The transmitting entity 150 may select the RLC PDU to be transmitted among prioritized RLC PDUs based on the PSIs associated with each RLC PDU. For example, the transmitting entity 150 may compare the PSI of ReTxPDU 2 and ReTxPDU L and select the most important RLC PDU, e.g., the one with the smallest PSI, for transmission and delivery to the lower layer.

The transmitting side of an AM RLC entity may prioritize the transmission of RLC control PDUs over AMD PDUs. The transmitting side of an AM RLC entity may prioritize transmission of AMD PDUs containing previously transmitted RLC SDUs or RLC SDU segments over transmission of AMD PDUs containing not previously transmitted RLC SDUs or RLC SDU segments. If prioritizationDelayCritical is configured, both initial transmission and retransmission of AMD PDUs without (segments of) delay-critical RLC SDUs may be depriortized.

In some embodiments, the transmitting entity 150 may first identify AMD PDUs for retransmission and exclude the AMD PDUs for initial transmission. Among the AMD PDUs for retransmission, the UE may prioritize the delay-critical AMD PDUs. If there are no delay-critical retransmission AMD PDUs, the transmitting entity 150 may select an RLC PDU for transmission among the AMD PDUs for retransmission. For example, the transmitting entity 150 may first identify ReTxPDU 1-L and prioritize ReTxPDU 2 and ReTxPDU L over other non-delay-critical AMD PDUs for retransmission. The transmitting entity 150 may consider PSI in addition to delay-criticality for prioritizing RLC PDUs. The transmitting entity 150 may select the RLC PDU to be transmitted among prioritized RLC PDUs based on the PSIs associated with each RLC PDU. For example, the transmitting entity 150 may compare the PSI of ReTxPDU 2 and ReTxPDU L and select the most important RLC PDU, e.g., the one with the smallest PSI, for transmission and delivery to the lower layer.

The transmitting side of an AM RLC entity may prioritize the transmission of RLC control PDUs over AMD PDUs. The transmitting side of an AM RLC entity may prioritize the transmission of AMD PDUs containing previously transmitted RLC SDUs or RLC SDU segments over the transmission of AMD PDUs containing not previously transmitted RLC SDUs or RLC SDU segments. If prioritizationDelayCritical is configured, the transmitting side of an AM RLC may prioritize the retransmission of AMD PDUs containing (segments of) delay-critical RLC SDUs over the retransmission of AMD PDUs without (segments of) delay-critical RLC SDUs.

In some instances, the RLC may identify delay-critical RLC SDUs for the purpose of data volume calculation for DSR. The RLC SDUs may be associated with a delay-critical indicator at the time of data volume calculation.

In some instances, pending RLC PDUs for retransmission are included in data volume calculation for DSR. However, being considered for data volume calculation may not be equivalent to being delay-critical.

In some embodiments, the RLC may be configured to apply prioritization based on delay-criticality. Radio resource control (RRC) signaling may configure the RLC to apply prioritization based on delay-criticality. For example, a parameter, e.g., prioritizationDelayCritical, may be introduced in the information element (IE) of RLC configuration, e.g., RLC-Config.

Prioritization based on delay-criticality may cause out-of-order transmission of RLC PDUs. In some embodiments, out-of-order delivery, e.g., to PDCP layer, may be enabled at the receiver side. Out-of-order delivery may allow prioritized AMD PDUs to be delivered to PDCP more quickly, especially when there is no segmentation such that the PDCP can directly process the received RLC SDU to obtain PDCP PDU.

In some embodiments, transmission of AMD PDUs containing delay-critical RLC SDUs or RLC SDU segments may be prioritized over RLC control PDUs, e.g., status PDUs.

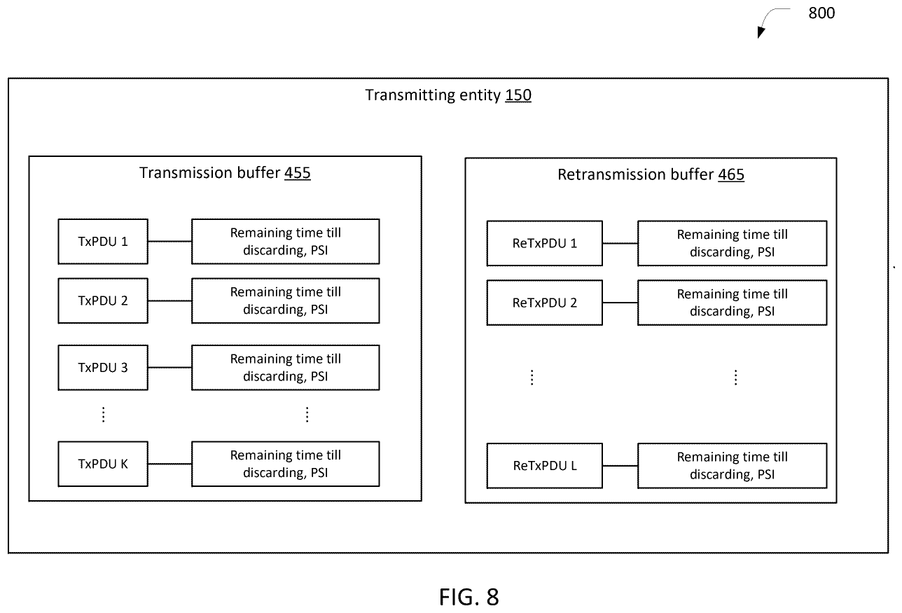

FIG. 8 illustrates other examples of prioritization at a transmitting entity 150 in accordance with some embodiments. The transmitting entity may include a transmission buffer 455. Transmission buffer 455 may contain RLC PDUs buffered for transmission, e.g., TxPDU 1-K. Each RLC PDU may be associated with one or more parameters. In some embodiments, each RLC PDU may be associated with a parameter indicating the remaining time until discarding. The value of the remaining time until discarding of an RLC SDU or an RLC PDU may be obtained based on the discard timer of the associated PDCP SDU. In some embodiments, each RLC PDU may be associated with a PSI. One or more parameters may include a PSI. The PSI of the RLC PDU may be the PSI of the corresponding PDU set.

In some embodiments, the AM RLC may determine the prioritization based on the remaining time until the corresponding PDUCP SDUs are discarded. The AM RLC may prioritize transmission of AMD PDUs containing RLC SDU or RLC SDU segments corresponding to PDCP SDUs with the smallest remaining time until discarding. For example, the transmitting entity 150 may determine the RLC PDU among TxPDU 1-K and RxTxPDU 1-L, which have the shortest remaining time until discarding and delivering it to the lower layer for transmission.

The transmitting entity 150 may apply prioritization based on the remaining time until discarding when at least one AMD PDU is considered delay-critical. When none of the AMD PDUs is determined to be delay-critical, the transmitting entity 150 may prioritize retransmission PDUs over initial transmission PDUs.

In some embodiments, the AMD PDUs, initial transmission or retransmission, may be prioritized over RLC control PDU, e.g., status PDUs, if the remaining time till discarding of their PDCP SDUs is smaller than a time threshold.

In some embodiments, the transmitting entity 150 may consider PSI for prioritizing RLC PDUs. For example, the transmitting entity may first determine a subset of RLC PDUs based on their PSI and then, among them, identify the one with the shortest remaining time until discarding.

In some embodiments, if the remaining time till discarding for a PDCP SDU (or its associated PDU set) is too short, e.g., less than 1 ms or 2 ms, to accommodate for air-interface or processing delays. In this condition, the RLC entity may not prioritize the RLC SDUs or RLC SDU segments corresponding to such PDCP SDUs, even if they are considered as delay-critical. The transmitting entity 150 may be configured with a lower bound threshold. The RLC transmitting entity 150 may prioritize the AMD PDUs that contain delay-critical RLC SDUs or RLC SDU segments whose remaining time until discarding is larger than the lower bound threshold. By definition, the remaining time until discarding of delay-critical RLC SDUs is smaller than an upper bound threshold. The transmitting entity 150 may consider AMD PDUs whose remaining time falls into the range between the lower bound threshold and the upper bound threshold.

In some embodiments, the AMD PDUs (initial transmission or retransmission) may be prioritized over RLC control PDUs, e.g., status PDUs, if the remaining time until discarding of their PDCP SDUs falls into the range between the lower bound threshold and the upper bound threshold.

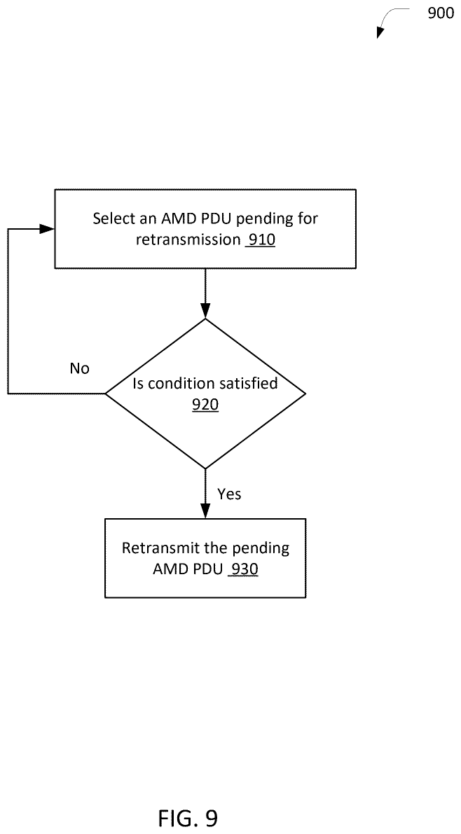

FIG. 9 illustrates another operation flow/algorithmic structure 900 in accordance with some embodiments. The algorithmic structure 900 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 108 or base station 1400, or components thereof, for example, baseband processor circuitry 1404A.

In some embodiments, retransmitting a pending AMD PDU may be performed autonomously, e.g., independent of the status report NACK.

The operation flow/algorithmic structure 900 may include, at 910, selecting an AMD PDU pending retransmission. For example, the transmitting entity 150 may select the AMD PDU associated with the TX_Next_Ack for retransmission or the AMD PDU in the retransmission buffer 465 with the shortest remaining time until discarding.

The operation flow/algorithmic structure 900 may include, at 920, determining whether a condition is met, regardless of whether an ACK or NACK associated with the selected AMD PDU is received. The condition may be: at least one of the RLC SDU or RLC SDU segment of the pending AMD PDU becomes delay-critical; the remaining time until PDCP discarding of at least one of the RLC SDU or RLC SDU segment of the pending AMD PDU satisfies a time threshold; at least one packet that belongs to the same PDU set as the RLC SDU or RLC SDU segment of the pending AMD PDU becomes delay-critical; or the remaining time until PDCP discarding of at least one packet that belongs to the same PDU set as the RLC SDU or RLC SDU segment of the pending AMD PDU satisfies a time threshold.

If operation flow 900 at 920 determines that the condition is met, operation flow 900 may proceed to operation flow at 920. Otherwise, the operation flow may return to 910.

The operation flow/algorithmic structure 900 may include, at 930, retransmitting the selected AMD PDU.

In one embodiment, the transmitting entity 150 may perform retransmission of all pending AMD PDUs that satisfy certain criteria, e.g., the ones that contain delay-critical RLC SDU or the ones that contain packets with remaining time until discarding shorter than a threshold.

In one embodiment, the transmitting entity 150 may receive an instruction from its peer entity 160. In response to the instruction, the transmitting entity 150 may perform retransmission of all pending AMD PDUs that satisfy certain criteria, e.g., the ones that contain delay-critical RLC SDU or the ones that contain packets with the remaining time until discarding that is shorter than a threshold. The instruction may be a dynamic signal such as a MAC CE, RLC control PDU, or a PDCP control PDU.

In some embodiments, the prioritization rule, in addition to embodiments and examples described above, of the AMD PDU may further consider whether the AMD PDU contains RLC SDU (or segments) that correspond to packet(s) of an important or less important PDU set. In some instances, the AMD PDU containing RLC SDU (or segments) corresponding to packets of an important PUD set may be prioritized. In other instances, the AMD PDU containing RLC SDU (or segments) corresponding to packets of a less-important PDU set may be de-prioritized.

In one embodiment, additional prioritization based on PSI may be activated or deactivated for the DRB. For example, the PSI of the packets corresponding to the RLC SDU (or segments) are only considered when the PSI-based discarding is activated. Otherwise, the PSI is not taken into account for AMD PDU prioritization.

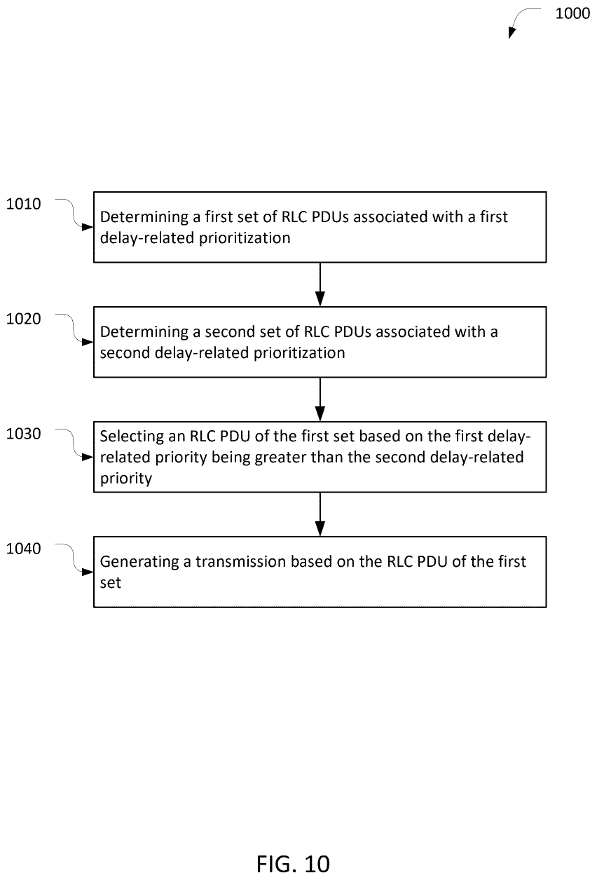

FIG. 10 illustrates another operation flow/algorithmic structure in accordance with some embodiments. The algorithmic structure 1000 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 1000 may include, at 1010, determining a first set of RLC PDUs associated with a first delay-related prioritization. The first delay-related prioritization may be prioritization based on delay-criticality. The first set of RLC PDU may include delay-critical PDUs. The RLC PDUs may be RLC AMD PDUs.

In some embodiments, the first set may include the delay-critical RLC PDUs. Selecting the delay-critical RLC PDUs may include selecting RLC PDUs containing a delay-critical RLC SDU or SDU segments and adding the delay-critical RLC PDU to the first set.

In some embodiments, the first set may include RLC PDUs for initial transmission, RLC PDUs for retransmission, or both.

The operation flow/algorithmic structure 1000 may include, at 1020, determining a second set of RLC PDUs associated with a second delay-related prioritization. The second delay-related prioritization may be prioritization based on delay-criticality. The second set of RLC PDU may include non-delay-critical PDUs. The RLC PDUs may be RLC AMD PDUs.

In some embodiments, the second set may include RLC PDUs for initial transmission, RLC PDUs for retransmission, or both.

The operation flow/algorithmic structure 1000 may include, at 1030, selecting an RLC PDU of the first set based on the first delay-related priority being greater than the second delay-related priority. For example, the RLC PDU of the first set may be related to a priority of delay-critical PDUs, and the second delay-related priority may be related to a priority of non-delay-critical PDUs. Delay-critical PDUs may have greater priority than non-delay-critical PDUs.

The operation flow/algorithmic structure 1000 may include, at 1040, generating a transmission based on the rLC PDU of the first set. The selected RLC PDU may be delivered to the lower layer for transmission.

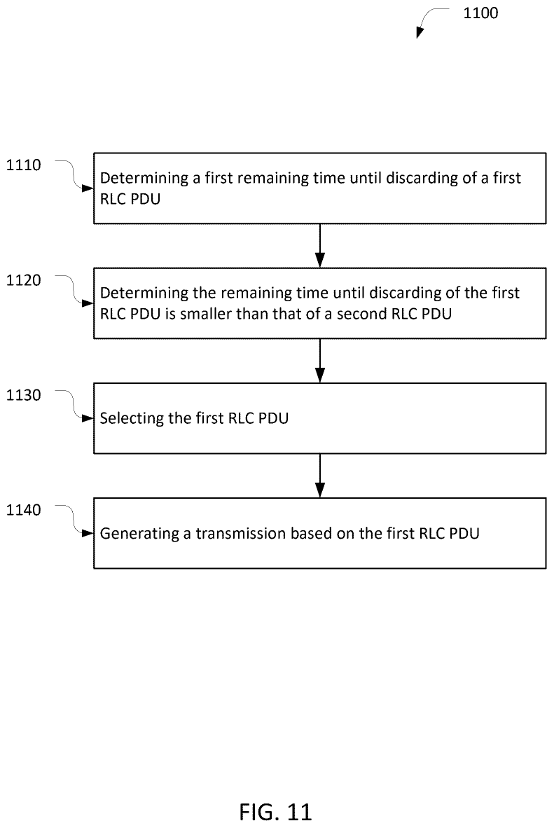

FIG. 11 illustrates another operation flow/algorithmic structure 1100 in accordance with some embodiments. The algorithmic structure 1100 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 1100 may include, at 1110, determining a remaining time until discarding of a first RLC PDU. The remaining time until discarding of the first RLC PDU may be associated with the discard timer of the PDCP PDU associated with the first RLC PDU.

The operation flow/algorithmic structure 1100 may include, at 1120, determining the remaining time until discarding of the first RLC PDU is smaller than that of a second RLC PDU.

The operation flow/algorithmic structure 1100 may include, at 1130, selecting the first RLC PDU. In some instances, selecting the first RLC PDU is based on determining that the remaining time until discarding the first RLC PDU is smaller than that of the second RLC PDU.

In some embodiments, the transmitting entity may determine that the first remaining time until discarding is smaller than a first threshold. In some embodiments, the transmitting entity may determine that the first remaining time until discarding is greater than a second threshold. In some embodiments, the transmitting entity may determine that the remaining time until discarding the first RLC PDU is between a first and second threshold. The first and second thresholds may be configured.

The operation flow/algorithmic structure 1100 may include, at 1140, generating a transmission based on the first RLC PDU. The transmitting entity may deliver the RLC PDU to the lower layer.

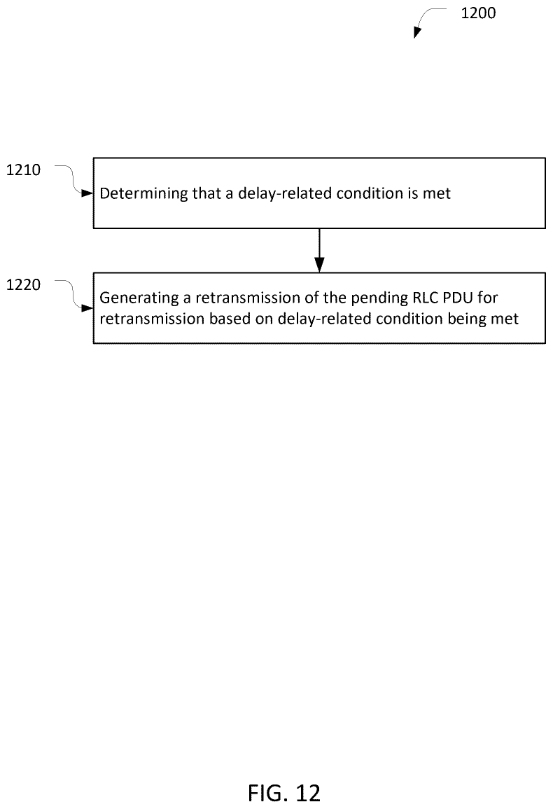

FIG. 12 illustrates an operation flow/algorithmic structure in accordance with some embodiments. The algorithmic structure 1200 may be implemented by an RLC transmitting entity such as, for example, the transmitting entity 150 of a UE, such as, for example, the UE 104 or UE 1300, or components thereof, for example, baseband processor circuitry 1304A; or the transmitting entity 150 of a base station, such as, for example, the base station 108 or base station 1400, or components thereof, for example, baseband processor circuitry 1404A.

The operation flow/algorithmic structure 1200 may include, at 1210, determining that a delay-related condition is met. The condition may include a pending RLC PDU for retransmission, which is a delay-critical RLC PDU, or a remaining time associated with the pending RL CPDU for retransmission that is smaller than a threshold.

In some embodiment, the transmitting entity 150 may receive an instruction for retransmission from its peer entity. The instruction may be a MAC CE, or a RLC control PDU, or a PDCP control PDU.

The operation flow/algorithmic structure 1200 may include, at 1220, generating a retransmission of a pending RLC PDU for retransmission based on delay-related conditions being met. The transmitting entity 150 may autonomously, e.g., independent of receiving an ACK or NACK, retransmit an RLC PDU.

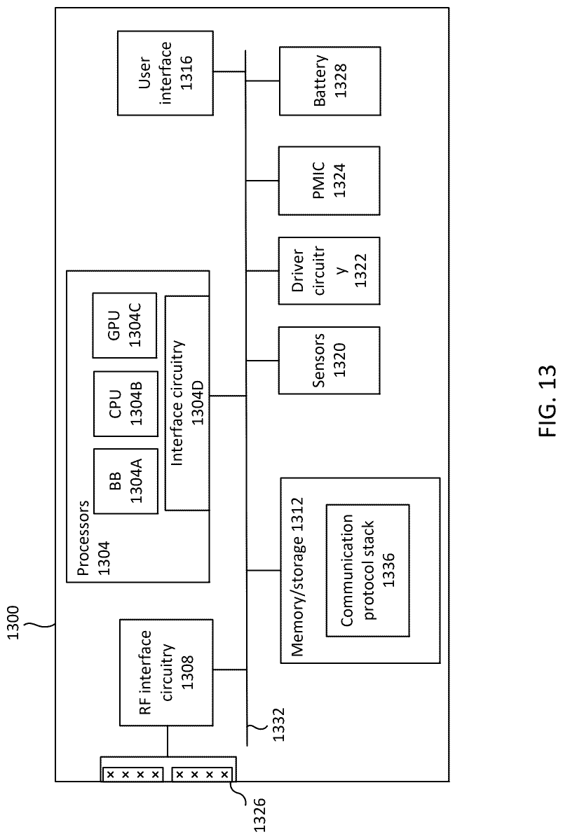

FIG. 13 illustrates a UE 1300 in accordance with some embodiments. The UE 1300 may be similar to and substantially interchangeable with the UE 104.

The UE 1300 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smartwatch), or Internet-of-things devices.

The UE 1300 may include processors 1304, RF interface circuitry 1308, memory/storage 1312, user interface 1316, sensors 1320, driver circuitry 1322, power management integrated circuit (PMIC) 1324, antenna 1326, and battery 1328. The components of the UE 1300 may be implemented as integrated circuits (ICs), portions thereof, discrete electronic devices, or other modules, logic, hardware, software, firmware, or a combination thereof. The block diagram of FIG. 13 is intended to show a high-level view of some of the components of the UE 1300. However, some of the components shown may be omitted, additional components may be present, and different arrangements of the components shown may occur in other implementations.

The components of the UE 1300 may be coupled with various other components over one or more interconnects 1332, which may represent any type of interface, input/output, bus (local, system, or expansion), transmission line, trace, or optical connection that allows various circuit components (on common or different chips or chipsets) to interact with one another.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage 1312 to cause the UE 1300 to perform operations as described herein. The processors 1304 may also include interface circuitry 1304D to communicatively couple the processor circuitry with one or more other components of the UE 1300.

In some embodiments, the baseband processor circuitry 1304A may access a communication protocol stack 1336 in the memory/storage 1312 to communicate over a 3GPP-compatible network. In general, the baseband processor circuitry 1304A may access the communication protocol stack 1336 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1308.

The baseband processor circuitry 1304A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1312 may include one or more non-transitory, computer-readable media that include instructions (for example, communication protocol stack 1336) that may be executed by one or more of the processors 1304 to cause the UE 1300 to perform various operations described herein.

The memory/storage 1312 includes any type of volatile or non-volatile memory that may be distributed throughout the UE 1300. In some embodiments, some of the memory/storage 1312 may be located on the processors 1304 themselves (for example, memory/storage 1312 may be part of a chipset that corresponds to the baseband processor circuitry 1304A), while other memory/storage 1312 is external to the processors 1304 but accessible thereto via a memory interface. The memory/storage 1312 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1308 may include transceiver circuitry and a radio frequency front module (RFEM) that allows the UE 1300 to communicate with other devices over a radio access network. The RF interface circuitry 1308 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1326 and proceed to filter and amplify (with a low-noise amplifier) the signal. The signal may be provided to a receiver of the transceiver that down-converts the RF signal into a baseband signal that is provided to the baseband processor of the processors 1304.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1326.

In various embodiments, the RF interface circuitry 1308 may be configured to transmit/receive signals in a manner compatible with NR access technologies.

The antenna 1326 may include antenna elements to convert electrical signals into radio waves to travel through the air and to convert received radio waves into electrical signals. The antenna elements may be arranged into one or more antenna panels. The antenna 1326 may have antenna panels that are omnidirectional, directional, or a combination thereof to enable beamforming and multiple input, multiple output communications. The antenna 1326 may include microstrip antennas, printed antennas fabricated on the surface of one or more printed circuit boards, patch antennas, or phased array antennas. The antenna 1326 may have one or more panels designed for specific frequency bands including bands in FR1 or FR2.

The user interface 1316 includes various input/output (I/O) devices designed to enable user interaction with the UE 1300. The user interface 1316 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1300.

The sensors 1320 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1322 may include software and hardware elements that operate to control particular devices that are embedded in the UE 1300, attached to the UE 1300, or otherwise communicatively coupled with the UE 1300. The driver circuitry 1322 may include individual drivers allowing other components to interact with or control various input/output (I/O) devices that may be present within or connected to the UE 1300. For example, driver circuitry 1322 may include a display driver to control and allow access to a display device, a touchscreen driver to control and allow access to a touchscreen interface, sensor drivers to obtain sensor readings of sensors 1320, and control and allow access to sensors 1320, drivers to obtain actuator positions of electro-mechanic components or control and allow access to the electro-mechanic components, a camera driver to control and allow access to an embedded image capture device, audio drivers to control and allow access to one or more audio devices.

The PMIC 1324 may manage power provided to various components of the UE 1300. In particular, with respect to the processors 1304, the PMIC 1324 may control power-source selection, voltage scaling, battery charging, or DC-to-DC conversion.

A battery 1328 may power the UE 1300, although in some examples, the UE 1300 may be mounted deployed in a fixed location and may have a power supply coupled to an electrical grid. The battery 1328 may be a lithium-ion battery, a metal-air battery, such as a zinc-air battery, an aluminum-air battery, a lithium-air battery, and the like. In some implementations, such as in vehicle-based applications, the battery 1328 may be a typical lead-acid automotive battery.

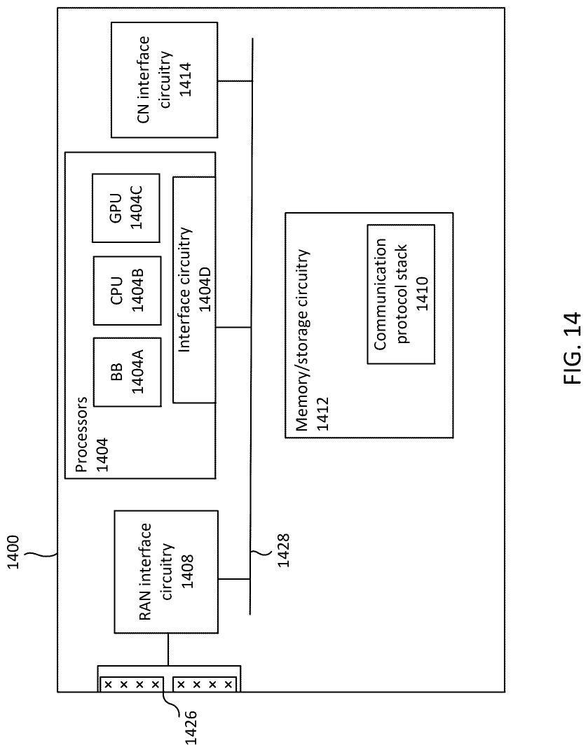

FIG. 14 illustrates a network device 1400 in accordance with some embodiments. The network device 1400 may be similar to and substantially interchangeable with base station 108.

The network device 1400 may include processors 1404, RF interface circuitry 1408 (if implemented as a base station), core network (CN) interface circuitry 1414, memory/storage circuitry 1412, and antenna structure 1426.

The components of the network device 1400 may be coupled with various other components over one or more interconnects 1428.

The processors 1404, RF interface circuitry 1408, memory/storage circuitry 1412 (including communication protocol stack 1410), antenna structure 1426, and interconnects 1428 may be similar to like-named elements shown and described with respect to FIG. 13.

The processors 1404 may include processor circuitry such as, for example, baseband processor circuitry (BB) 1404A, central processor unit circuitry (CPU) 1404B, and graphics processor unit circuitry (GPU) 1404C. The processors 1404 may include any type of circuitry or processor circuitry that executes or otherwise operates computer-executable instructions, such as program code, software modules, or functional processes from memory/storage circuitry 1412 to cause the UE 1300 to perform operations as described herein. The processors 1404 may also include interface circuitry 1404D to communicatively couple the processor circuitry with one or more other components of the network device 1400.

The CN interface circuitry 1414 may provide connectivity to a core network, for example, a 5^{th} Generation Core network (5GC) using a 5GC-compatible network interface protocol such as carrier Ethernet protocols or some other suitable protocol. Network connectivity may be provided to/from the network device 1400 via a fiber optic or wireless backhaul. The CN interface circuitry 1414 may include one or more dedicated processors or FPGAs to communicate using one or more of the aforementioned protocols. In some implementations, the CN interface circuitry 1414 may include multiple controllers to provide connectivity to other networks using the same or different protocols.

It is well understood that the use of personally identifiable information should follow privacy policies and practices generally recognized as meeting or exceeding industry or governmental requirements for maintaining users' privacy. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry described above in connection with one or more of the preceding figures may be configured to operate according to one or more of the examples set forth below. For another example, circuitry associated with a UE, base station, or network element described above in connection with one or more of the preceding figures may be configured to operate according to one or more of the examples set forth below in the example section.

### EXAMPLES

In the following sections, further exemplary embodiments are provided.

Example 1 includes a method including: determining a first plurality of radio link control (RLC) protocol data units (PDUs) are associated with a first delay-related priority; determining a second plurality of RLC PDUs are associated with a second delay-related priority; selecting an RLC PDU of the first plurality of RLC PDUs based on the first delay-related priority being greater than the second delay-related priority; and generating a transmission based on the RLC PDU.

Example 2 includes the method of example 1 or some other examples herein, wherein the first delay-related priority is a priority associated with a delay-critical PDU and the second delay-related priority is a priority associated with a non-delay-critical PDU.

Example 3 includes the method of examples 1 or 2 or some other example herein, wherein the RLC PDUs of the first plurality of RLC PDUs are delay-critical RLC acknowledgment mode data (AMD) PDUs.

Example 4 includes the method of any of examples 1-3 or some other example herein, wherein determining a first plurality of RLC PDUs includes: selecting an RLC PDU containing a delay-critical RLC SDU, or a delay-critical RLC SDU segment; and associating the RLC PDU with the first plurality of RLC PDUs.

Example 5 includes the method of any of examples 1-4 or some other example herein, wherein: the first plurality of RLC PDUs includes one or more RLC PDU for initial transmission or one or more RLC PDUs for retransmission; and the second plurality of RLC PDUs includes one or more RLC PDU for initial transmission or one or more PDUs for retransmission.

Example 6 includes the method of any of examples 1-5 or some other example herein, wherein: the first plurality of RLC PDUs includes one or more RLC PDUs for initial transmission and one or more RLC PDUs for retransmission; and the RLC PDU of the first plurality of RLC PDUs is selected from one or more RLC PDUs for retransmission.

Example 7 includes the method of any of examples 1-6 or some other example herein, wherein: the first plurality of RLC PDUs includes delay-critical RLC PDUs for retransmission; and the second plurality of RLC PDUs includes non-delay-critical RLC PDUs for retransmission.

Example 8 includes the method of any of examples 1-7 or some other example herein, further including: processing a configuration received from a base station to configure prioritization based on delay-criticality, wherein said prioritizing the first plurality of RLC PDUs is based on the configuration.

Example 9 includes the method of any of examples 1-8 or some other example herein, wherein the configuration is a radio resource control (RRC) parameter in an RRC information element (IE).

Example 10 includes the method of any of examples 1-9 or some other example herein, further including: processing a configuration enabling an out-of-order delivery to an upper layer.

Example 11 includes the method of any of examples 1-10 or some other example herein, wherein: the first plurality of RLC PDUs includes one or more data RLC PDUs; and the second plurality of RLC PDUs includes one or more control RLC PDUs.

Example 12 includes the method of any of examples 1-11 or some other example herein, further including: determining a PDU set importance (PSI) associated with the RLC PDU; and prioritizing the RLC PDU from the first plurality of RLC PDUs over RLC PDUs of the second plurality of RLC PDUs or RLC PDUs of the first plurality of RLC PDUs based on the first delay-related priority, the second delay-related priority, and the PSI.

Example 13 includes the method of any of examples 1-12 or some other example herein, wherein said determining the PSI associated with the RLC PDU includes: determining an RLC service data unit (SDU) or an RLC SDU segment associated with the RLC PDU; determining a packet of a PDU set, the packet associated with the RLC SDU or the RLC SDU segment; and associating a PSI of the PDU set to the PSI of the RLC PDU.

Example 14 includes the method of any of examples 1-13 or some other example herein, further including: processing a configuration to enable or disable a prioritization based on PSIs; and performing said prioritization based on the configuration.

Example 15 includes a method including: determining a first remaining time until discarding associated with a first radio link control (RLC) protocol data unit (PDU); determining that the first remaining time until discarding associated with the first RLC PDU is smaller than a second remaining time until discarding associated with a second RLC PDU; selecting the first RLC PDU based on said determining that the first remaining time until discarding associated with the first RLC PDU is smaller than a second remaining time until discarding associated with a second RLC PDU; and generating a transmission including the first RLC PDU.

Example 16 includes the method of example 15 or some other example herein, wherein determining the first time until discarding associated with the first RLC PDU includes:
determining a packet data convergence protocol (PDCP) service data units (PDUs) associated with the first RLC PDU; determining a remaining time until discarding associated with the PDCP SDU; and assigning the remaining time until discarding associated with the PDCP SDU to the first time until discarding associated with the first RLC PDU.

Example 17 includes the method of examples 15 or 16 or some other example herein, further including: determining that at least one RLC PDU is associated with a delay-related priority; and performing said selecting the first RLC PDU based on said determining that at least one RLC PDU is associated with a delay-related priority.

Example 18 includes the method of any of examples 15-17 or some other example herein, wherein delay-related priority is a priority associated with a delay-critical PDU.

Example 19 includes the method of any of examples 15-18 or some other example herein, wherein the first RLC PDU is an RLC acknowledgment mode data (AMD) PDU and the second RLC PDU is an RLC control PDU, and the method further includes: determining that the first remaining time until discarding is smaller than a threshold.

Example 20 includes the method of any of examples 15-19 or some other example herein, further including: processing a configuration including the threshold.

Example 21 includes the method of any of examples 15-20 or some other example herein, further including: determining that the first remaining time until discarding is greater than a first threshold and is smaller than a second threshold.

Example 22 includes the method of any of examples 15-21 or some other example herein, further including: processing a configuration including the first threshold or the second threshold.

Example 23 includes the method of any of examples 15-22 or some other example herein, further including: determining a PDU set importance (PSI) associated with the first RLC PDU; and prioritizing the first RLC PDU over the second RLC PDU further based on the PSI.

Example 24 includes the method of any of examples 15-23 or some other example herein, wherein said determining the PSI associated with the first RLC PDU includes: determining an RLC service data unit (SDU) or an RLC SDU segment associated with the first RLC PDU; determining a packet of a PDU set, the packet associated with the RLC SDU or the RLC SDU segment; and assigning the PSI of the PDU set to the PSI of the first RLC PDU.

Example 25 includes the method of any of examples 15-24 or some other example herein, further including: processing a configuration to enable or disable a prioritization based on PSIs; and performing said prioritization based on the configuration.

Example 26 includes a method including: determining a delay-related condition associated with a pending RLC PDU for retransmission is met; and generating a retransmission of the pending RLC PDU for retransmission based on said determining that the delay-related condition is met.

Example 27 includes the method of example 26 or some other example herein, wherein determining that the delay-related condition is met comprises: determining that the pending RLC PDU for retransmission is a delay-critical RLC PDU; or determining that a remaining time associated with the pending RLC PDU for retransmission is smaller than a threshold.

Example 28 includes the method of examples 26 or 27 or some other example herein, determining that the pending RLC PDU for retransmission is a delay-critical RLC PDU includes: determining that at an RLC service data unit (SDU) or an RLC SDU segment associated with the pending RLC PDU is delay-critical; or determining that a packet of a PDU set associated with an RLC service data unit (SDU) or RLC SDU segment of the pending RLC PDU for retransmission is a delay-critical RLC PDU.

Example 29 includes the method of any of examples 26-28 or some other example herein, wherein determining that a remaining time associated with the pending RLC PDU for retransmission is smaller than a threshold includes: determining that a remaining time until discarding of a packet data convergence protocol (PDCP) associated with an RLC service data unit (SDU) or an RLC SDU segment of the pending RLC PDU for retransmission is smaller than the threshold; or determining that a remaining time until discarding of a packet data convergence protocol (PDCP) associated with a PDU set is smaller than the threshold, wherein the pending RLC PDU for retransmission is associated with the PDU set.

Example 30 includes the method of any of examples 26-29 or some other example herein, further including: receiving an instruction from an RLC receiving entity; and generating the retransmission further based on the instruction.

Example 31 includes the method of any of examples 26-30 or some other example herein, wherein the instruction is included in a medium access control (MAC) control element (CE), an RLC control PDU, or a packet data convergence protocol (PDCP) control PDU.

Example 32 includes the method of any of examples 26-31 or some other example herein, the method further including: determining a PSI associated with the pending RLC PDU for retransmission; and prioritizing the pending RLC PDU for retransmission based on the PSI.

Example 33 includes the method of any of examples 26-32 or some other example herein, wherein said determining the PSI associated with the pending RLC PDU for retransmission includes: determining an RLC service data unit (SDU) or an RLC SDU segment associated with the pending RLC PDU for retransmission; determining a packet of a PDU set, the packet associated with the RLC SDU or the RLC SDU segment; and assigning the PSI of the PDU set to the PSI of the pending RLC PDU for retransmission.

Example 34 includes the method of any of examples 26-33 or some other example herein, wherein the pending RLC PDU for retransmission is a first pending RLC PDU for retransmission, the PSI is a first PSI, and the method further includes: determining a second pending RLC PDU for retransmission; and determining a second PSI associated with the second pending RLC PDU for retransmission, wherein said prioritizing the first pending RLC PDU for retransmission based on the first PSI includes: comparing the first PSI and the second PSI; and selecting the first pending RLC PDU for retransmission based on said comparing the first PSI and the second PSI.

Example 35 includes the method of any of examples 26-34 or some other example herein, further including: processing a configuration to enable or disable a prioritization based on PSIs; and performing said prioritization based on the configuration

Another example may include an apparatus comprising means to perform one or more elements of a method described in or related to any of examples 1-35, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-35, or any other method or process described herein.

Another example may include an apparatus comprising logic, modules, or circuitry to perform one or more elements of a method described in or related to any of examples 1-35, or any other method or process described herein.

Another example may include a method, technique, or process as described in or related to any of examples 1-35, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-35, or portions thereof.

Another example may include a signal as described in or related to any of examples 1-35, or portions or parts thereof.

Another example may include a datagram, information element, packet, frame, segment, PDU, or message as described in or related to any of examples 1-35, or portions or parts thereof, or otherwise described in the present disclosure.

Another example may include a signal encoded with data as described in or related to any of examples 1-35, or portions or parts thereof, or otherwise described in the present disclosure.

Another example may include a signal encoded with a datagram, IE, packet, frame, segment, PDU, or message as described in or related to any of examples 1-35, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-35, or portions thereof.

Another example may include a computer program comprising instructions, wherein execution of the program by a processing element is to cause the processing element to carry out the method, techniques, or process as described in or related to any of examples 1-35, or portions thereof.

Another example may include a signal in a wireless network as shown and described herein.

Another example may include a method of communicating in a wireless network, as shown and described herein.

Another example may include a system for providing wireless communication, as shown and described herein.

Another example may include a device for providing wireless communication, as shown and described herein.

Unless explicitly stated otherwise, any of the above-described examples may be combined with any other example (or combination of examples). The foregoing description of one or more implementations provides illustration and description but is not intended to be exhaustive or to limit the scope of embodiments to the precise form disclosed. Modifications and variations are possible in light of the above teachings or may be acquired from the practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
determining a delay-related condition associated with a pending radio link control (RLC) protocol data unit (PDU) for retransmission is met; and
generating a retransmission of the pending RLC PDU for retransmission, based on said determining that the delay-related condition is met.

2. The method of claim 1, wherein determining that the delay-related condition is met comprises:
determining that the pending RLC PDU for retransmission is a delay-critical RLC PDU; or
determining that a remaining time associated with the pending RLC PDU for retransmission is smaller than a threshold.

3. The method of claim 2, wherein determining that the pending RLC PDU for retransmission is a delay-critical RLC PDU comprises:
determining that an RLC service data unit (SDU) or an RLC SDU segment associated with the pending RLC PDU is delay-critical; or
determining that a packet of a PDU set associated with an RLC service data unit (SDU) or RLC SDU segment of the pending RLC PDU for retransmission is a delay-critical RLC PDU.

4. The method of claim 2, wherein determining that a remaining time associated with the pending RLC PDU for retransmission is smaller than a threshold comprises:
determining that a remaining time until discarding of a packet data convergence protocol (PDCP) associated with an RLC service data unit (SDU) or an RLC SDU segment of the pending RLC PDU for retransmission is smaller than the threshold; or
determining that a remaining time until discarding of a packet data convergence protocol (PDCP) associated with a PDU set is smaller than the threshold, wherein the pending RLC PDU for retransmission is associated with the PDU set.

5. The method of claim 1, further comprising:
receiving an instruction from an RLC receiving entity; and
generating the retransmission further based on the instruction.

6. The method of claim 5, wherein the instruction is included in a medium access control (MAC) control element (CE), an RLC control PDU, or a packet data convergence protocol (PDCP) control PDU.

7. The method of claim 1, the method further comprising:
determining importance information associated with the pending RLC PDU for retransmission; and
prioritizing the pending RLC PDU for retransmission based on the importance information.

8. The method of claim 7, wherein said determining the importance information associated with the pending RLC PDU for retransmission comprises:
determining an RLC service data unit (SDU) or an RLC SDU segment associated with the pending RLC PDU for retransmission;
determining a packet of a PDU set, the packet associated with the RLC SDU or the RLC SDU segment; and
assigning importance information of the PDU set to the importance information of the pending RLC PDU for retransmission.

9. The method of claim 7, wherein the pending RLC PDU for retransmission is a first pending RLC PDU for retransmission, the importance information is first importance information, and the method further comprises:
determining a second pending RLC PDU for retransmission; and
determining second importance information associated with the second pending RLC PDU for retransmission, wherein said prioritizing the first pending RLC PDU for retransmission based on the first importance information comprises:
comparing the first importance information and the second importance information; and
selecting the first pending RLC PDU for retransmission based on said comparing the first importance information and the second importance information.

10. The method of claim 9, further comprising:
processing a configuration to enable or disable a prioritization based on importance information; and
performing said prioritization based on the configuration.

11. An apparatus comprising:
processing circuitry to:
determine a delay-related condition associated with a pending radio link control (RLC) protocol data unit (PDU) for retransmission is met; and
generate a retransmission of the pending RLC PDU for retransmission, based on said determining that the delay-related condition is met; and
interface circuitry coupled with the processing circuitry to enable communication.

12. The apparatus of claim 11, wherein to determine that the delay-related condition is met the processing circuitry is to:
determine that the pending RLC PDU for retransmission is a delay-critical RLC PDU; or
determine that a remaining time associated with the pending RLC PDU for retransmission is smaller than a threshold.

13. The apparatus of claim 12, wherein to determine that the pending RLC PDU for retransmission is a delay-critical RLC PDU the processing circuitry is to:
determine that an RLC service data unit (SDU) or an RLC SDU segment associated with the pending RLC PDU is delay-critical; or
determine that a packet of a PDU set associated with an RLC service data unit (SDU) or RLC SDU segment of the pending RLC PDU for retransmission is a delay-critical RLC PDU.

14. The apparatus of claim 12, wherein to determine that a remaining time associated with the pending RLC PDU for retransmission is smaller than a threshold the processing circuitry is to:
determine that a remaining time until discarding of a packet data convergence protocol (PDCP) associated with an RLC service data unit (SDU) or an RLC SDU segment of the pending RLC PDU for retransmission is smaller than the threshold; or
determine that a remaining time until discarding of a packet data convergence protocol (PDCP) associated with a PDU set is smaller than the threshold, wherein the pending RLC PDU for retransmission is associated with the PDU set.

15. The apparatus of claim 11, wherein the processing circuitry is further to:
determine importance information associated with the pending RLC PDU for retransmission; and
prioritize the pending RLC PDU for retransmission based on the importance information.

16. A method comprising:
determining a first plurality of radio link control (RLC) protocol data units (PDUs) are associated with a first delay-related priority;
determining a second plurality of RLC PDUs are associated with a second delay-related priority;
selecting an RLC PDU of the first plurality of RLC PDUs based on the first delay-related priority being higher than the second delay-related priority; and
generating a transmission based on the RLC PDU.

17. The method of claim 16, wherein the first delay-related priority is a priority associated with a delay-critical PDU and the second delay-related priority is a priority associated with a non-delay-critical PDU.

18. The method of claim 16, wherein the RLC PDUs of the first plurality of RLC PDUs are delay-critical RLC acknowledgment mode data (AMD) PDUs.

19. The method of claim 16, wherein determining a first plurality of RLC PDUs comprises:
selecting an RLC PDU containing a delay-critical RLC SDU, or a delay-critical RLC SDU segment; and
associating the RLC PDU with the first plurality of RLC PDUs.

20. The method of claim 16, wherein:
the first plurality of RLC PDUs includes one or more RLC PDU for initial transmission or one or more RLC PDUs for retransmission; and
the second plurality of RLC PDUs includes one or more RLC PDU for initial transmission or one or more PDUs for retransmission.
